(19) United States
(12) Patent Application Publication
(10) Pub. No.: US 2007/0090662 A1
(43) Pub. Date: Apr. 26, 2007

(54) Composite tailgate with a one-piece structural panel that has integrated storage space

(75) Inventors: Kurt Katterloher, Mississauga (CA); Lassi M. Ojanen, Richmond Hill (CA); Frank Dodaro, Oakville (CA); Reid Allyn Bayly, Toronto (CA); Rudolph A. Schrempf, Brampton (CA)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/259,653

(22) Filed: Oct. 26, 2005

(51) Int. Cl. B62D 33/03

(52) U.S. Cl. 296/57.1

(57) ABSTRACT

The present invention relates to a composite tailgate providing a one piece structural member that has an integrated storage space. The tailgate is made of a structural member which has a skin attached to its exterior side and a hinged access panel that is attached to its interior side. A cap is used to secure the skin and hinged access panel to the structural member. The hinged access panel can be opened when the tailgate is in a flat position in order to create storage space. The size of the storage space depends on the size of the structural member. The tailgate and the components are made of composite materials in order to minimize the weight of the tailgate.

### FIELD OF THE INVENTION

The present invention relates to a composite tailgate that has a single structural panel which creates an integrated storage space.

### BACKGROUND OF THE INVENTION

Some vehicles, such as a truck, have a tailgate that swings down to create a flat surface that is even with the truck bed. Tailgates can be made of many types of materials. Some tailgates, known as composite tailgates, are made of composite parts. There are also hybrid tailgates which make use of both steel and composite parts. A third type of tailgate is a tailgate that is made of all steel. However, all of these tailgates have the same limitations when it comes to the ability to incorporate additional functional features.

It is ideal for the size of a tailgate to change depending on the truck model, and based on the year to year model. However, in order to reduce the cost of producing a tailgate, many truck models share tailgate designs due to the high tooling costs. By using the same type of tooling on all tailgate models it is very difficult to have variations between the tailgate features. Thus, any styling variations of the tailgates are limited to small changes. Moreover, as truck sizes get larger the tailgates also increase in size which makes for a heavier tailgate that is harder for the user to open and close. Therefore, it would be ideal to provide a composite tailgate that weighs less than an all steel tailgate or a hybred tailgate. In addition, a composite tailgate requires less tooling which in turn lowers the cost when compared to an all steel tailgate. Finally, a composite tailgate is ideal because features can be added that could not be added on an all steel tailgate or that would be expensive to produce on an all steel tailgate.

### SUMMARY OF THE INVENTION

The present invention relates to a composite tailgate with a one piece structural member that has an integrated storage space. The tailgate is made of a single structural member which has a skin attached to its exterior side and a hinged access panel that is attached to its interior side. A cap is used to secure the skin to the structural member. The hinged access panel can be opened when the tailgate is in a flat position in order to give access to the storage space. Also, the hinged access panel can be latched to the cap to secure the hinged access panel while it is closed. The size of the storage space is dependent on the size of the structural member.

The production of this one piece composite tailgate will not require heavy duty presses or multiple tools. By reducing the amount of tools and presses needed to produce a composite tailgate, the initial capital investment will be decreased. Furthermore, by having a lower initial capital investment, it will make it more economical to have different tailgate designs on various truck models. In addition, the use of composite materials will make it easier to include different features on the tailgate. Since the composite materials are lighter than steel, it will make the tailgate easier for the user to open and close.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the tailgate in a position where the storage compartment is accessible;

FIG. 2 is an exploded perspective view of the tailgate's components when the tailgate is in an upright position;

FIG. 3A is a plan view of the tailgate in its preferred embodiment; and

FIG. 3B is a plan view of the tailgate in an alternate embodiment.

### DETAILED DESCRIPTION OF THE PREFERRED EMBODIMENTS

The following description of the preferred embodiment(s) is merely exemplary in nature and is in no way intended to limit the invention, its application, or uses.

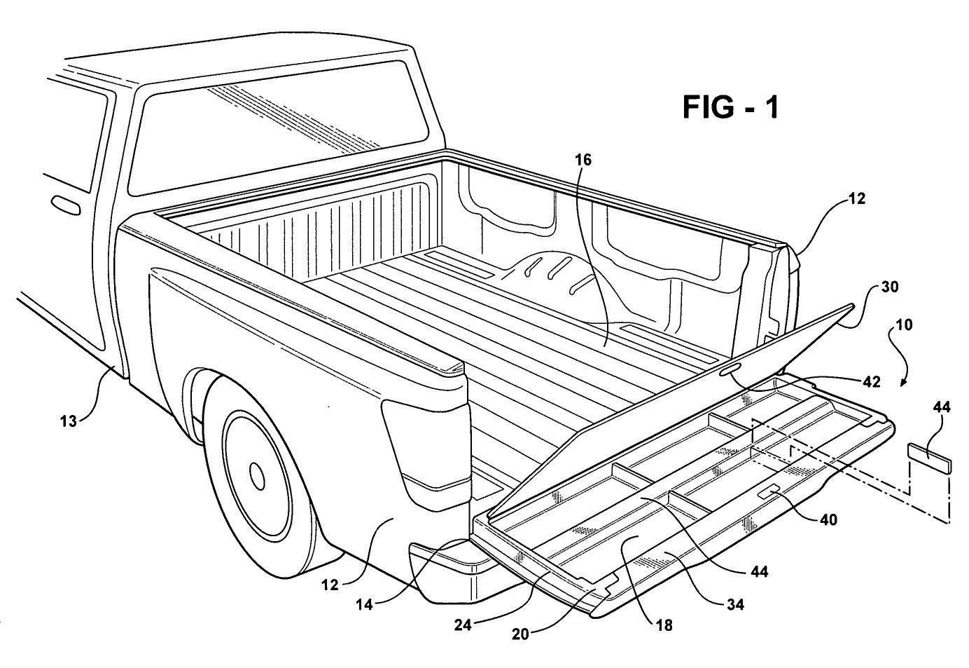

Referring to FIG. 1, a tailgate 10 is attached to the side walls 12 of a vehicle 13 at a hinge point 14. The tailgate 10 pivots with respect to the hinge point 14 in order for the tailgate 10 to move between an upright position and a position where the tailgate 10 creates a flat surface that is about the same height as the truck bed 16. The tailgate 10 has a storage compartment 18, which is created by several different elements.

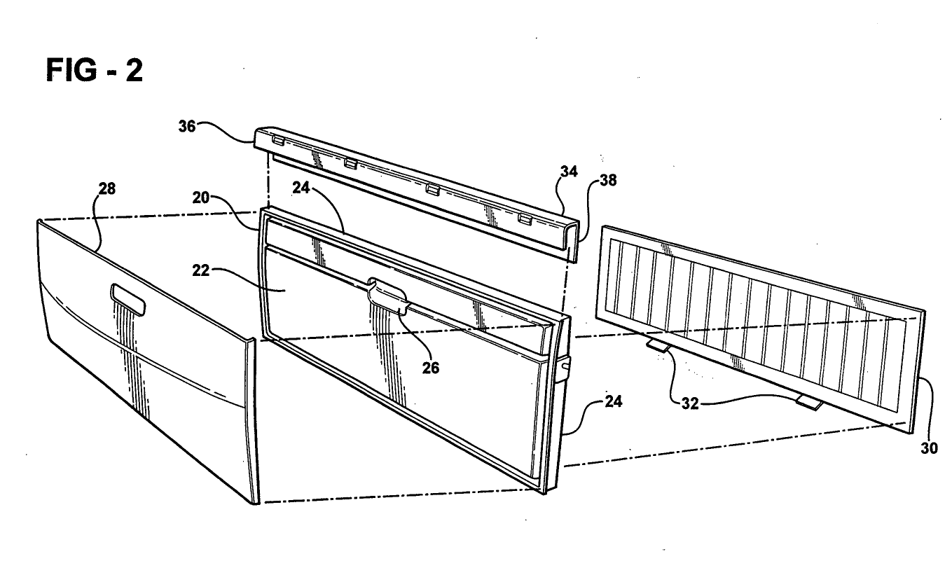

Referring to FIGS. 1, 2, and 3A, the first element that forms the storage compartment 18 is a single structural member 20. The structural member 20 has a base 22 which is on the exterior side of the tailgate 10. The structural member 20 also has four side walls 24 that are connected to the base 22 that extend away from the base 22. The distance that the side walls 24 extend away from the base 22 will be the depth of the storage compartment 18, which is also the width of the tailgate 10. Thus, the area of the storage compartment 18 is dependent on the size of the base 22 and the side walls 24. As the surface area base 22 and the height of the side walls 24 increase the area of the storage compartment 18 increases. Likewise, as the surface area of the base 22 and the height of the side walls 24 decrease, the area of the storage compartment 18 decreases.

In the preferred embodiment the structural member 20 is made of composite materials in order to minimize the weight of the tailgate 10. By having a structural member 20 made out of composite materials, features can be added to the structural member 20 with greater ease and less cost than an all steel tailgate. In addition, the structural member 20 has all of the elements that are needed to mount hardware (not shown) on the tailgate 10. For example, the structural member 20 has a depression 26, which can be used as a housing for the handle (not shown) that will control a latch (not shown) between the tailgate 10 and the side walls 12. Thus, when the latch is secured it would prevent the tailgate 10 from pivoting about the primary hinges 14 at undesirable times.

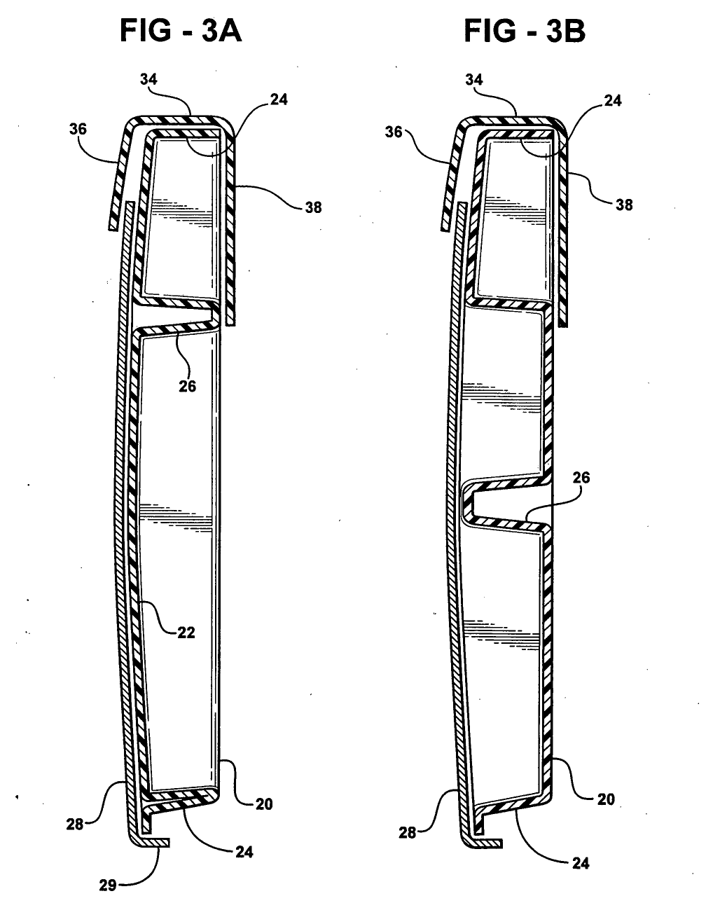

As discussed above, since the structural member 20 is made of composite materials, the structural member 20 can have any number of depressions 26 and the depressions 26 can be in any shape in order to accommodate any of the tailgate's 10 features. As depicted in FIG. 3B, the structural member 20 can be altered by changing the position of the depression 26 to create an alternate embodiment of the tailgate 10 without requiring an alteration to a skin 28 or any other elements of the tailgate 10.

In order to enclose the structural member 20 a skin 28 is placed against the base 22. The skin 28 creates an exterior surface area of the tailgate 10. The skin 28 is approximately the same size and shape as the base 22 so that the majority of the base 22 will be covered by the skin 28. The skin 28 completely extends to the end of the structural member 20 that is connected to the hinges 14. In addition, the skin 28 has a flange 29 that extends over one of the side walls 24. However, the skin 28 does not completely extend to the end of the structural member 20 that is farthest from the hinges 14. Thus, a portion of the structural member 20 remains exposed in relation to the skin 28. Furthermore, the skin 28 can be designed in a plurality of ways such that the tailgate's 10 hardware is accessible.

In a preferred embodiment the skin 28 is made of a composite material so that it minimizes the weight of the tailgate 10, and allows for design features to be added or changed without requiring an alteration of the structural member 20 or any other elements of the tailgate 10. It is preferred that the composite material used is a glass reinforced polyurethane. However, For example, three-dimensional features could be added to the skin 28 without requiring a change in the structural member 20. Another example is that the size of the skin 28 could be reduced without requiring an alteration to the structural member 20, thus a portion of the structural member 20 would be exposed as a design feature.

A hinged access panel 30 is placed on the opposite side of the structural member 20 as the skin 28. Thus, the hinged access panel 30 creates an interior surface of the tailgate 10. It is preferred that the hinged access panel 30 is connected to the structural member 20 at the end that is closest to the hinges 14. In addition, the hinged access panel 30 is connected to the structural member 20 using hinges 32 such that the hinged access panel 30 can pivot with respect to the hinges 32 in order to access the storage compartment 18. Therefore, the hinged access panel 30 will pivot about the hinges 32 in a manner that will give a user access to the storage compartment 18 while they are on the ground rather than being positioned on the opposite side, which would require the user to be in the truck bed 16 in order to access the storage compartment 18. It is preferred that at least two hinges 34 are used to connect the hinged access panel 30 to the structural members 20. When the hinged access panel 30 is attached by at least two hinges 32 the hinged access panel 30 has more stability as it is being raised and lowered. However, as the size of the tailgate 10, the structural member 20, and the hinged access panel 30 increase, it may be desirable to increase the number of hinges 32 used to connect the hinged access panel 30 to the structural member 20.

A cap 34 is placed over the structural member 20 and the skin 28 on the end of the structural member 20 that is the farthest from the hinges 14. The cap 34 is unshaped so that the outside portion of the cap 34 has an exterior lip 36 that extends over the skin 28. The cap 34 also has an interior lip 38 on the inside portion that is longer than the exterior lip 36. The interior lip 38 extends over the structural member 20 and under the hinged access panel 30. In addition, the cap 34 has a receiving depression 40 on the surface that contacts the hinged access panel 30. Also, the hinged access panel 30 has a latch 42 on the side that contacts the cap 34. The latch 42 is located on the hinged access panel 30 such that it aligns with the receiving depression 40. Therefore, the hinged access panel 30 can attach to the cap 34 in order to secure the hinged access panel 30 such that the hinged access panel 30 will remain closed. In addition, the hinged access panel 30 can be opened at any time by releasing the latch 42 from the receiving depression 40.

In addition, a divider 42 is inside the storage compartment 18. The divider 42 could be made of any type of material, but the preferred embodiment is a foam material in order to minimize the weight of the tailgate 10. Also, the divider 44 can be a single molded structure that is manufactured into various shapes in order to accommodate different size objects. In the alternative, the divider 44 could consist of several pre-manufactured pieces such that the size of the compartments could be varied depending on the size of the object being stored at any given time. No matter what material or design the divider 44 is, the purpose of the divider 44 is to prevent the objects that are being stored from rattling or shifting within the storage compartment 18.

In a preferred embodiment the tailgate 10 and the components discussed above are made of a composite material due to the high strength to low weight ratio of composite materials. In other words, composite materials are ideal because they have a high strength in relation to their weight when compared to other types of materials. It is preferred that the composite material used to construct the tailgate 10 is glass reinforced polyurethane. An alternative material that could be used is a sheet molding compound. In addition, by constructing the tailgate 10 out of composite materials, the design features of the tailgate 10 can be altered easier and at a lower cost than an all steel tailgate. For example, three-dimensional design features could be added to the hinged access panel 30 without requiring a change to the entire tailgate 10 or the structural member 20. Thus, it is more economical to have variations in tailgate designs between different vehicle models. Another example would be to include additional depressions in the structural member 20 where light modules could be located. The light modules would be placed between the structural member 20 and the skin 28. Also, the skin 28 could have additional features to enhance the light emitted by the light module. Furthermore, electrical wiring could be extended through the inner portion of the primary hinge 14 in order for the light modules to have power. Thus, it would be economical to have additional optional design features on the tailgate 10 even within the same truck model.

The description of the invention is merely exemplary in nature and, thus, variations that do not depart from the gist of the invention are intended to be within the scope of the invention. Such variations are not to be regarded as a departure from the spirit and scope of the invention.

1. A composite tailgate comprising:
a one piece structural member;
a skin, wherein said skin is adjacent to said structural member and forms the exterior side of said composite tailgate;
a storage compartment, a portion of said storage compartment formed by said structural member;
an access panel adjacent to said structural member on the opposite side as said skin; and
a cap, wherein said cap covers one end of said structural member.

2. (canceled)

3. The composite tailgate of claim 1, wherein said structural member has a base, and at least one side wall that extends away from said base and forms a portion of said storage compartment.

4. (canceled)

5. The composite tailgate of claim 1, wherein said access panel is attached to said structural member by at least one hinge.

6. The composite tailgate of claim 1, wherein said skin is made of a composite material allowing the size and shape of said skin to change without altering any portion of said structural member.

7. The composite tailgate of claim 1, wherein said cap has a short end that covers said structural member and a portion of said skin, and said cap has a long end that covers said structural member and extends under said access panel.

8. The composite tailgate of claim 1, wherein said structural member has at least one depression.

9. The composite tailgate of claim 1, further comprising a divider inside said storage compartment.

10. A composite tailgate comprising:
a structural member; and
a storage compartment, wherein said structural member forms a portion of said storage compartment.

11. The composite tailgate of claim 10, wherein said structural member has a base, and at least one side wall that extends away from said base and forms a portion of said storage compartment.

12. The composite tailgate of claim 10, further comprising a skin that is the exterior side of said composite tailgate, and said skin is adjacent to said structural member on the opposite side as said storage compartment.

13. The composite tailgate of claim 12, wherein said skin is made of a composite material allowing the size and shape of said skin to change without altering any portion of said structural member.

14. The composite tailgate of claim 10, further comprising an access panel, wherein said access panel is adjacent to said structural member on the same side as said storage compartment.

15. The composite tailgate of claim 14, where said access panel is attached to said structural member by at least one hinge.

16. The composite tailgate of claim 10, further comprising a cap that covers one end of said structural member.

17. The composite tailgate of claim 16, wherein said cap is u-shaped with one end longer than the other, such that a long end covers more of said structural member than a short end.

18. The composite tailgate of claim 10, wherein said structural member has at least one depression.

19. The composite tailgate of claim 10, further comprising a divider that is placed inside said storage compartment.

20. A composite tailgate comprising:
a structural member;
a skin, wherein said skin is adjacent said structural member and forms an exterior side of said tailgate;
an access panel, wherein said access panel is attached to said structural member on the opposite side as said skin, and said access panel is attached to said structural member by at least one hinge;
a cap, wherein said cap covers one end of said structural member; and,
a storage compartment, wherein said structural member has a base, at least one side wall that extends from said base, said base and said at least one side wall form a portion of said structural member, and a divider that is placed inside said storage compartment.

21. The composite tailgate of claim 9, wherein said divider is comprised of several pre-manufactured pieces, allowing the size of said storage compartment to be varied.

22. The composite tailgate of claim 21, wherein said several pre-manufactured pieces are separate from said storage compartment, and can be inserted into said storage compartment in various positions to adjust the size of said storage compartment.

23. The composite tailgate of claim 19, wherein said divider is comprised of several pre-manufactured pieces, allowing the size of said storage compartment to be varied.

24. The composite tailgate of claim 23, wherein said several pre-manufactured pieces are separate from said storage compartment, and can be inserted into said storage compartment in various positions to adjust the size of said storage compartment

25. The composite tailgate of claim 20, wherein said divider is comprised of several pre-manufactured pieces, allowing the size of said storage compartment to be varied.

26. The composite tailgate of claim 25, wherein said several pre-manufactured pieces are separate from said storage compartment, and can be inserted into said storage compartment in various positions to adjust the size of said storage compartment.
